(19) United States
(12) Patent Application Publication
(10) Pub. No.: US 2007/0290013 A1
(43) Pub. Date: Dec. 20, 2007

(54) Package for pouring a product

(76) Inventors: Satoshi Yamane, Higashinadaku (JP); Antonio Victor Angelo, Norwood, OH (US); Dennis John Ruehl, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/810,295

(22) Filed: Jun. 5, 2007

Related U.S. Application Data
(63) Continuation-in-part of application No. 11/196,969, filed on Aug. 4, 2005.
(60) Provisional application No. 60/600,970, filed on Aug. 12, 2004.

(51) Int. Cl. B65D 47/04; B67D 3/00

(52) U.S. Cl. 222/547; 222/564; 222/566

(57) ABSTRACT

A package for dispensing a pourable product has a first hollow body member, a second hollow body member, and a pouring spout. The first hollow body member has a first exterior surface and opposite therefrom a first interior surface which defines a first internal volume. The second hollow body member has a second exterior surface, a second interior surface, a flow-regulating passage, and a dispensing passage separate from the flow-regulating passage. The second exterior surface defines a second external volume smaller than the first internal volume. Opposite the second exterior surface, the second hollow interior surface defines a second internal volume. A fastener is formed on the second interior surface. The pouring spout is operatively connected to the dispensing passage.

### CROSS REFERENCE OF RELATED APPLICATIONS

This application is a continuation-in-part of U.S. application Ser. No. 11/196,969, filed Aug. 4, 2005, which claims the benefit of U.S. Provisional Application Ser. No. 60/600,970, filed Aug. 12, 2004.

### FIELD OF THE INVENTION

The present invention relates to a package for a granular or a fluid product. Specifically, the present invention relates to a transition which can be used to pour granular or fluid products.

### BACKGROUND OF THE INVENTION

Containers having transitions are well known in the art. Such containers have been used for a multitude of products including chemical packages, food packages, cleaning packages, and the like. The transitions are typically attached to the container for the purpose of directing any materials contained within the container out in a controlled manner. They also facilitate various means of closing a package, such as providing an area to which a lid or cap can be attached. The transitions associated with containers often have additional benefits relating to such areas as self-draining and flow-limiting capabilities.

Because a fluid product has different flowability characteristics than a granular product, a different transition is used for the fluid product than the granular product to provide ease of dispensability that can permit accurate, controlled dosing. For example, fluid products provide more of a steady rate of pouring or discharge whereas solid products do not provide the steady rate of pouring or discharge of product in a narrow bulk flow stream, especially when the width of the stream is narrow compared to a product's particle size. Thus, substantially different transitions are needed because of the different flowability characteristics of granular products versus fluid products.

However, in terms of materials and manufacturing, it is not sufficiently cost effective for use in mass production of transitions to have two separate transitions. In contrast, the cost of a typical product package must be kept to a minimum because, among other reasons, it is generally disposed of after substantially all of a product stored within has been dispensed. Thus, one transition which can be used for both fluid and granular products is desirable. Such a transition would be even more desirable if it can create a desirable consumer experience for a consumer using a fluid product as well as a consumer using a granular product. The present invention addresses these problems.

Accordingly, there is a need for a cost effective, mass produceable transition which can be used for both granular and fluid products. Moreover, the need exists for one transition which can be used for dispensing a granular product as well as a fluid product, which accurately pours to a desired location, and which is easy and convenient to use.

### SUMMARY OF THE INVENTION

The present invention relates to a package for dispensing a pourable product having a first hollow body member, a second hollow body member, and a pouring spout. The first hollow body member has a first exterior surface and opposite therefrom a first interior surface which defines a first internal volume. The second hollow body member has a second exterior surface, a second interior surface, a flow-regulating passage, and a dispensing passage separate from the flow-regulating passage. The second exterior surface defines a second external volume smaller than the first internal volume. Opposite the second exterior surface, the second hollow interior surface defines a second internal volume. A fastener is formed on the second interior surface. The pouring spout is operatively connected to the dispensing passage.

When the first internal volume is at least about 50% full of the pourable product, the package may be tilted for dispensing at a dispensing angle which causes the pourable product to flow from the first internal volume through the flow-regulating passage into the second internal volume and from the second internal volume through the dispensing passage out of the package. When the flow rate is measured and calculated at a dispensing angle of 120°, the standard deviation is less than about 20 grams of the average flow rate. When the flow rate is measured and calculated at a dispensing angle of 150°, the standard deviation is less than about 20 grams of the average flow rate.

In one embodiment, the package is used to store and dispense granular products including but not limited to solid particulates, laundry detergents, automatic dish washing detergents and the like. In one aspect, the optimum flow of such granular products is achieved if the mass-based median particle size of the granular product is in the range of from about 300 to about 1200 microns, in the range of from about 400 to about 1000 microns, or even in the range of from about 500 to about 800 microns. In one aspect, the specific gravity of the bulk product is in the range of from about 500 g/L to about 1200 g/L, from about 600 to about 1100 g/L, or from about 700 to about 1000 g/L or even of from about 800 g/L to about 900 g/L. In one aspect, the amount of fine particles is less than 150 microns in the granular product and is less than 20% by weight, less than 10% by weight, or even less than 5% by weight.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1a is a cut-away side view of an embodiment of the package of the present invention;

FIG. 1b is perspective view of an embodiment of a second hollow body member;

FIG. 2 is a cut-away side view of an embodiment of the package of the present invention during dispensing;

FIG. 3 is a partial cut-away side view of a comparative package; and

FIG. 4 is a close-up side view of an embodiment of the second hollow body member.

FIG. 5 is a side view of an alternative embodiment of the package of the present invention.

FIG. 6 is a front view of an alternative embodiment of the second hollow body member of the present invention.

FIG. 7 is a cross-section view along line 6-6 of an alternative embodiment of the second hollow body member of the present invention.

FIG. 8 is a cross-section view along line 8-8 of an alternative embodiment of the second hollow body member of the present invention.

The figures herein are not necessarily drawn to scale.

### DETAILED DESCRIPTION OF THE INVENTION

Section A will provide terms which will assist the reader in best understanding the features of the invention, but not to introduce limitations in the terms inconsistent with the context in which they are used in this specification. These definitions are not intended to be limiting. Section B will discuss the package of the present invention. Section C will discuss the Flow Rate Test Method. Section D will discuss examples of the present invention.

### A. Terms

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”.

As used herein, the term “granules” and variants thereof mean any non-fluid composition.

As used herein, the term “fluids” and variants thereof mean any composition capable of wetting. The composition can include solids or gases in suitably subdivided form, but the overall composition excludes product forms which are substantially nonfluid overall, such as tablets or granules.

By the term “pourable product,” it is meant herein a pourable product which can be either a granule or a fluid. For example, the granules can be a granular food, a granular detergent, chemicals, etc. In another embodiment of the invention herein, the product can be a granular product selected from the group consisting of salt, flour, baking soda, baking powder, sugar, and a mixture thereof. In an embodiment of the invention herein, the product can be a granular detergent selected from the group consisting of a laundry detergent composition, an autodishwash composition, a disinfecting composition, a cleaning composition, a personal cleansing composition, and a mixture thereof. The granular product should be a free-flowing granular product. In an embodiment herein, the granular product has an approximately regular shape, preferably a regular shape, such as a sphere, a crystal, a cube, etc. Without intending to be limited by theory, it is believed that typically, the more regular the shape of the particles in the granular product, the better the free-flowing properties of the granular product. In another embodiment herein, the granular product has a median particle diameter, which is the mass median particle diameter calculated by methods known in the art. In another embodiment herein, the granular product has a median particle size and a standard deviation of less than about 30% of the average flow rate, or from about 0% to about 30% of the average flow rate. The pourable product can also be fluid.

### B. Package of the Present Invention

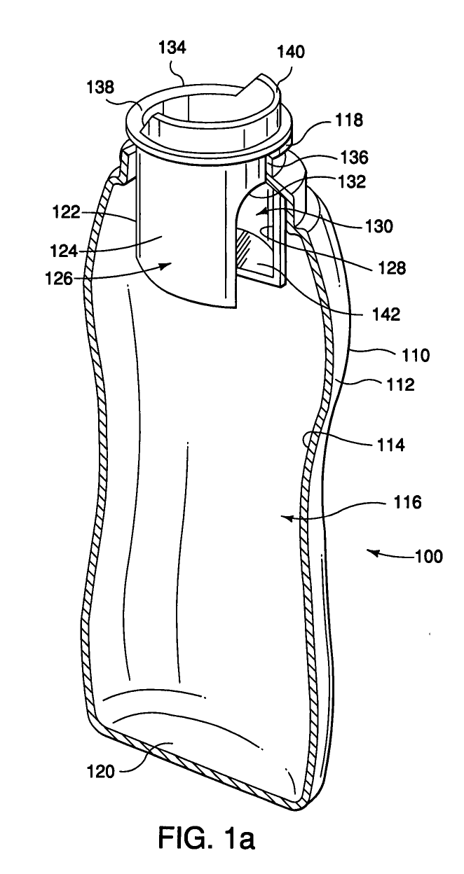

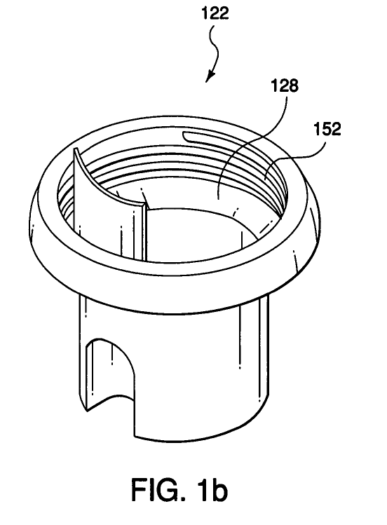

Turning to FIG. 1a which shows a cut-away side view of a package, 100, having a first hollow body member, 110, having a first exterior surface, 112, and a first interior surface, 114, opposite the first exterior surface, 112. The first interior surface, 114, defines a first internal volume, 116, which is further bounded by the mouth, 118, which is formed where the first exterior surface, 112, meets the first interior surface, 114. Thus, in this embodiment, the first internal volume, 116, ends at the plane formed by the mouth, 118. Opposite the mouth, 118, is a package bottom, 120, which in FIG. 1a is flat so as to allow the package, 100, to stably rest.

FIG. 1a also shows a second hollow body member, 122, which in this embodiment is distinct from the first hollow body member, 110. The second hollow body member, 122, has a second exterior surface, 124, which defines a second external volume, 126, which is smaller than the first internal volume, 116. In an embodiment herein, the second external volume, 126, can be less than about 50% of the first internal volume, 116. The second hollow body member, 122, also has a second interior surface, 128, opposite the second exterior surface, 124. The second interior surface, 128, defines a second internal volume, 130. In an embodiment herein, the second internal volume, 130, can be from about 1% to about 25% of the first internal volume, 116. In another embodiment herein, the second internal volume, 130 can be from about 2% to about 15% of the first internal volume, 116.

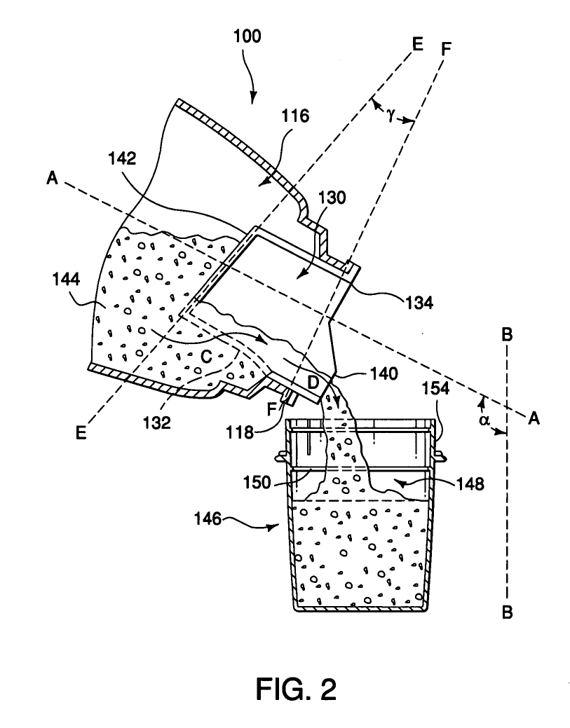

Referring FIG. 1b, disposed on the second interior surface, 128, of the second hollow body member, 122, are fasteners, 152, (e.g. threads), which cooperate with fasteners, 154, (e.g. threads) (shown in FIG. 2) on cap, 146, (shown in FIG. 2) when the cap, 146, (shown in FIG. 2) is fixed to the second hollow body member, 122. The fastener can be of any suitable object which joins the second hollow body member, 122, to the cap, 146 (shown in FIG. 2). The fastener can be including, but not limited to, lugs, grooves, threads, or plug seals.

Referring to FIG. 1a, the second hollow body member, 122, contains a flow-regulating passage, 132, which leads from the second exterior surface, 124 to the second interior surface, 128. Distal and separate from the flow-regulating passage, 132, is a dispensing passage, 134, that leads from the second interior surface, 128, to the second exterior surface, 124.

In FIG. 1a, generally the second hollow body member, 122, can be fixedly joined to the first hollow body member, 110, in any way known in the art. The second hollow body member, 122, can also be monolithic with the first hollow body member, 110, for example, by molding the first hollow body member, 110, and the second hollow body member, 122, as one piece. In one non-limiting example, the second hollow body member, 122, can be fixedly joined to the first hollow body member, 110, by friction fitting that snaps parts together, gluing, and/or melting. In another non-limiting example, the second hollow body member, 122, can also be a continuation of the first hollow body member, 110, by folding or compressing a portion of the first hollow body member, 110, and turning the first hollow body member, 110, inwards upon itself to create the second hollow body member, 122.

In FIG. 1a, the second exterior surface, 124, can be affixed to the mouth, 118, via an adhesive, 136. However, the second exterior surface may also be affixed to the mouth, 118, by, for example, a pressure seal, an adhesive seal, a locking closure, a screw-type closure, a snap-fit closure, a heat seal, an ultrasonic seal, and/or a plug-seal and may optionally be air-tight and/or water-tight as desired for example, to prevent oxidation of the pourable product, absorption of moisture from the air, and/or water damage to the pourable product. In an embodiment herein, the second exterior surface, 124, is removably affixed to the mouth, 118. Also in FIG. 1a, the dispensing passage, 132, is bounded by an edge, 138, at the second exterior surface, 124. The edge, 138, is affixed to the mouth, 118, so that a majority of the second hollow body member, 122, is contained within the first internal volume, 116, but this not need be the case. In the present invention, the second hollow body member, 122, need only be at least partially within the first internal volume, 116.

In FIG. 1a, connected to the dispensing passage, 134, is a pouring spout, 140, which helps direct the pourable product, 144, (see FIG. 2) when the package, 100, is tilted for dispensing (see FIG. 2.). The pouring spout, 140, can have a height of from about 0 mm to about 110 mm. The second hollow body member, 122, has a base, 142, opposite the dispensing passage, 134. The flow-regulating passage, 132, extends from near the mouth, 118, to the base, 142. In addition, the base, 142, of the second hollow body member, 122, is slanted towards the flow-regulating passage, 132, so that when the package, 100, is placed flat on the package bottom, 120, on a flat surface, any pourable product, 144, (see FIG. 2) which remains in the second internal volume, 130, will flow back through the flow-regulating passage, 132, and into the first internal volume, 116.

FIG. 2, shows a cut-away side view of the package, 100, of the present invention tilted during dispensing. A line, A-A, drawn perpendicular to the package bottom (not shown in FIG. 2) and in FIG. 2, line A-A is also perpendicular to the plane formed by the mouth, 118, forms a dispensing angle, α, with a vertical line, B-B, drawn perpendicular to the ground. When the package, 100, contains the pourable product, 144, and is tilted to a dispensing angle, α, of about 150°, the pourable product, 144, flows from the first internal volume, 116, through the flow-regulating passage, 132, into the second internal volume, 130, as indicated by arrow C. The pourable product, 144, then flows from the second internal volume, 130, through the dispensing passage, 134, and off of the pouring spout, 140, as indicated by arrow D, and into the cap, 146. The cap, 146, has a dosing device, 148, and a measuring indicator, 150, to advise the user how much of the pourable product, 144, to dose. Since the pourable product, 144, flows out of the second internal volume, 130, and therefore the pouring spout, 140, at a substantially constant rate, it is easy to accurately measure and dose the pourable product, 144. Furthermore, in the embodiment of FIG. 2, the flow-regulating passage, 132, extends from near the mouth, 118 to the base, 142, so that at a given dispensing angle of, for example, 150°, substantially all of the pourable product, 144, will flow out of the first internal volume, 116, through the flow-regulating passage, 132, into the second internal volume, 130, and out of the dispensing passage, 134. In FIG. 2, the base, 142, is flat and defines the imaginary line E-E. The mouth, 118, also defines the imaginary line F-F. A base angle, γ, is formed by the intersection of imaginary lines E-E and F-F. The base angle, γ can be between from about 0° to about 180°.

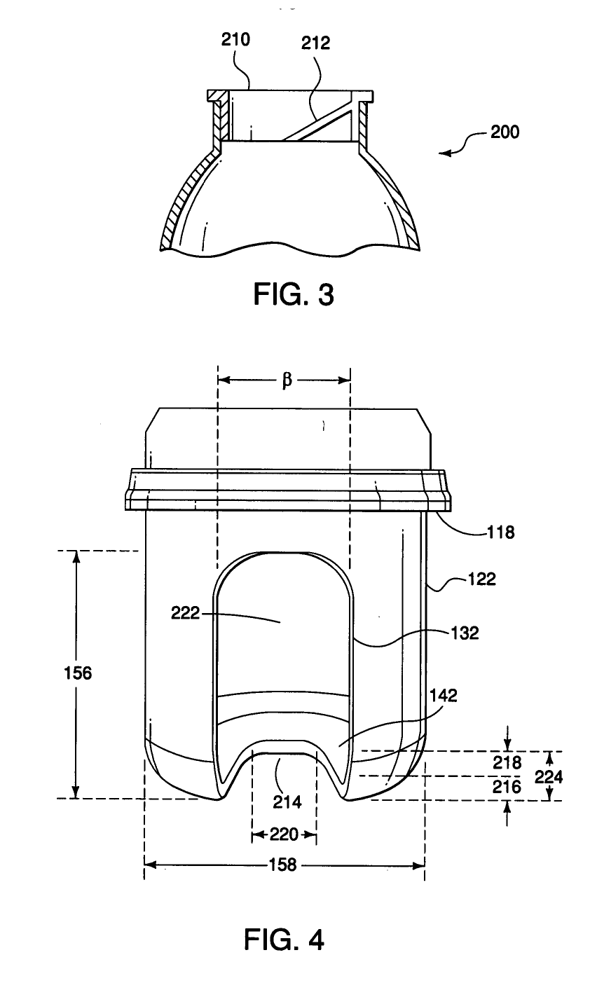

FIG. 3 shows a partial cut-away side view of a comparative package, 200, for dispensing a pourable product, 144, (shown in FIG. 2) with a pouring hole, 210, and an inclined plane, 212, to the interior of the pouring hole, 210. However, when the comparative package, 200, is tilted at various degrees from about 100° to about 150°, the pourable product, 144, (shown in FIG. 2) therein flows out of the pouring hole, 210, at dramatically different rates.

FIG. 4 shows a close-up side view of a second hollow body member, 122, and the flow-regulating passage, 132, therein.

The second hollow body member, 122, comprises a base 142. The width, 158, of the base, 142, of the second hollow body member 122 can vary. In one non-limiting example, the width, 158, of the base, 142, can be from about 0 mm to about 127 mm. In yet another non-limiting example, the width, 158, of the base, 142, of the second hollow body member 122 can be about 127 mm. The width, 158, of the base, 142, of the second hollow body member 122 provides an increased surface area for the consumer to pour any unused product back into the package, specifically the first hollow body member, 110 (shown in FIG. 1).

The base, 142, of the second hollow body member 122 can be any shape. Accordingly, the base, 142 can be of any suitable shape including, but not limited to, circular, oval, flattened circular, elliptical, and any combination thereof.

The flow-regulating passage, 132, extends from the base, 142, of the second hollow body member 122 to almost to the edge, 138 (shown in FIG. 1). The flow regulating passage 132 has a side 222 and a base 214. The base 214 is formed in the base 142 of the base 142 of the second hollow body member 122. The base 214 has a width 220 and a length 224. The length 224 has a first end 216, a second end 218 opposite the first end 216. As shown in FIG. 2, the base 214 (shown in FIG. 4) of the flow regulating passage 132, which can be void, allows the pourable product, 144, to flow from the first internal volume, 116, through the flow-regulating passage, 132, into the second internal volume, 130, as indicated by arrow C. As previously stated, the base 214 can be void or any material as long as pourable product 144 can flow from the first internal volume, 116, through the flow-regulating passage, 132, into the second internal volume, 130, as indicated by arrow C.

The side 222 of the flow regulating passage 132 has a width β and a height 156. The width, β, can be from about 1.0 to about 2.5 mm, and is substantially wider than the average particle diameter of the pourable product, 144. In FIG. 4, the width, β, extends from near the mouth, 118, to the base, 142. In an embodiment herein, the width, β, is adjacent to the mouth, 118. In another embodiment herein, the width, β, of the flow-regulating passage, 132, is less than about 0.2 mm from the mouth, 118. In an embodiment herein, the width, β, of the flow-regulating passage, 132, is at least about 5 times wider than the median particle diameter, or from about 5 times to about 1,000 times wider than the median particle diameter, or from about 10 times to about 100 times wider than the median particle diameter. Without being limited by theory, it is believed that such a wide flow-regulating passage, 132, will enhance the free-flow properties of the pourable product, 144.

The width β of the side 222 can have the same or different width 220 of the base 214. In this embodiment, the width β of the side 222 and the width 220 of base 214 have the same width which is from about 1.5 to about 2 mm.

The side 222 of the flow-regulating passage, 132, has a height, 156, which can be from about 1.0 to about 2.5 mm, and is substantially wider than the average particle diameter of the pourable product, 144 (shown in FIG. 2).

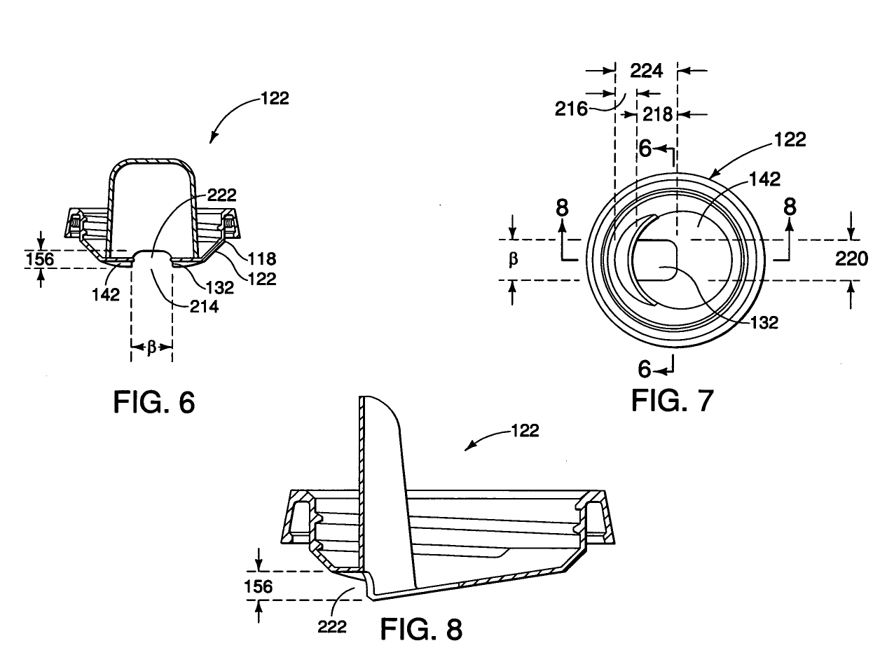

Referring to FIG. 6, FIG. 7, and FIG. 8, in one non-limiting example, the flow-regulating passage 132 has a side 222 and a base 214. The side 222 has a height of about 6 mms. Referring to FIG. 7, the flow regulating passage 132 can extend into the base 142 and is formed in the base of the second hollow body member 122. In this embodiment, the base 214 of the flow regulating passage 132 has a width 220 and a length 224. Referring again to FIGS. 6-8, the side 222 of the flow regulating passage has a width β of about 15 mm. The height 156 of the side 222 is about 20 mm.

The package and/or any portion thereof may be formed of a variety materials such as a plastic or polymers, rubber, glass, metal, wood, or a combination thereof. An embodiment of the package and/or container includes rubber, plastic, polyester, and a combination thereof, and another embodiment includes polyethylene, polypropylene, polyethylene terephthalate, polypropylene terephthalate, polycarbonate, polystyrene, ethyl vinyl alcohol, thermoplastic elastomer, or a combination thereof. Flexible package and/or container parts preferably contain at least a portion of thermoplastic elastomer. Textured surfaces may also be employed so as to enhance gripping and/or friction, if desired.

Preferred production processes are blow molding, injection molding, vacuum forming, thermoforming, casting, stereo lithography, selective laser scintering, any rapid prototyping technology, and a combination thereof. The various individual package and/or portions thereof may be formed with different materials, and/or by different processes, as desired. Optional, but preferred characteristics of the package material include color, tinting, UV blocking agents, translucency, transparency, or opaqueness. Examples of the UV blocking agent useful herein include titanium dioxide, benzophenone, hydroxy-benzophenone, benzotriazole, and a mixture thereof. Such UV blocking agents are commonly available from, for example, Sumitomo Chemical, Tokyo Japan; Kyodo Chemical, Tokyo Japan; Asahi Denka, Tokyo Japan; Ciba Giegy, Tokyo Japan; and others. In one embodiment, the package can be colored. In another embodiment, the package could be transparent or translucent and optionally contains a UV blocking agent to absorb, reflect, or otherwise reduce the amount of UV light penetrating the container to reach the granular product so as to thereby reduce possible UV damage thereto, fading of the product color, especially if colored speckles are present, and/or yellowing of the granular product caused by exposure to UV radiation. Other optional characteristics of the package material include easy formation to the desired shape(s), resistance to the product and the applicable pH ranges, temperature, durability, coloration, coatings and/or resiliency. In an embodiment of the invention, the package material should be resistant to damage and deformation at temperatures from about −10° C. to about 90° C. The package may be sized to hold whatever volume is desirable. In an embodiment herein, the first internal volume, 116, is from about 0.5 mL to about 10 L, or from about 1 mL to about 5 L. In an embodiment herein for a granular detergent the first internal volume, 116, is from about 150 mL to about 3 L or from about 200 mL to about 1 L.

### C. Pourable Product Used with Container

The container may contain any pourable product such as a detergent.

Detergents

In one embodiment, the package is used to store and dispense granular products including but not limited to solid particulate laundry detergents, automatic dish washing detergents and the like. In one aspect, the optimum flow of such granular products is achieved if the mass-based median particle size of the granular product is in the range from about 300 to about 1200 microns, in the range from about 400 to about 1000 microns, or even in the range from about 500 to about 800 microns. In one aspect, the specific gravity of the bulk product is in the range from about 500 g/L to about 1200 g/L, from about 600 to about 1100 g/L, from about 700 to about 1000 g/L or even from about 800 g/L to about 900 g/L. In one aspect, the amount of fine particles less than 150 microns in the granular product is less than 20% by weight, less than 10% by weight or even less than 5% by weight. Without being bound by theory, it is believed that the cumulative surface area of the fine particles act to increase the frictional resistance to bulk flow. When a granular product contains a large amount of fine particles, it impairs the smooth bulk flow of the granules out of the container.

In another embodiment, the granular product is a granular laundry detergent. There are many ways to produce granular products including but not limited to blow drying and roller drying. In a spray drying process, an aqueous detergent slurry is sprayed through a tower to produce highly porous detergent granules. In another process various detergent components are dry mixed after which they are agglomerated with a binder such as a nonionic or anionic surfactant. In one aspect, a finished granular detergent is comprised of a mixture of dry detergent granules produced by blow drying and agglomeration processes. In one aspect, the optimum physical properties of the finished product are obtained using a ratio of blown granule to agglomerated detergent of about 1:1 to about 1:5.

While not essential for the purposes of detergents, the non-limiting list of adjuncts illustrated hereinafter are suitable for use in the instant compositions and may be desirably incorporated in certain detergents, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, structurants, clay soil removal/anti-redeposition agents, brighteners, suds suppressors, dyes, fabric hueing agents, perfumes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

i.) Bleaching Agents

The cleaning compositions may comprise one or more bleaching agents. Suitable bleaching agents other than bleaching catalysts include, but are not limited to, photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include, but are not limited to preformed peracids, sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof and bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group and nonanoyloxybenzene sulphonate (NOBS).

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

ii.) Surfactants

The cleaning compositions may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

iii.) Builders

The cleaning compositions may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

iv.) Chelating Agents

The cleaning compositions herein may contain a chelating agent. Suitable chelating agents include, but are not limited to, copper, iron and/or manganese chelating agents and mixtures thereof. When a chelating agent is used, the subject composition may comprise from about 0.005% to about 15% or even from about 3.0% to about 10% chelating agent by weight of the subject composition.

v.) Dye Transfer Inhibiting Agents

The cleaning compositions may also include, but are not limited to, one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

vi.) Brighteners

The cleaning compositions can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

vii.) Dispersants

The compositions can also contain dispersants. Suitable water-soluble organic materials include, but are not limited to, the homo- or co-polymeric acids or their salts, in which the polycarboxylic acid comprises at least two carboxyl radicals separated from each other by not more than two carbon atoms.

viii.) Enzymes

The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

ix. Enzyme Stabilizers

Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

x. Catalytic Metal Complexes

Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

### C. Method for Determining the Median Particle Size of the Granular Product

The median particle size test is conducted to determine the median particle size of the material using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E11) sieves #8 (2360 um), #12 (1700 um), #16 (1180 um), #20 (850 um), #30 (600 um), #40 (425 um), #50 (300 um), #70 (212 um), #100 (150 um) is required. The prescribed Machine-Sieving Method is used with the above sieve nest. The granular product material is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate. An example of the above data representation is given in ISO 9276-1:1998, “Representation of results of particle size analysis—Part 1: Graphical Representation”, FIG. A.4. The median particle size (D50), for the purpose of this invention, is defined as the abscissa value at the point where the cumulative mass percent is equal to 50 percent, and is calculated by a straight line interpolation between the data points directly above (a50) and below (b50) the 50% value using the following equation:
D50=10ˆ[Log(Da50)−(Log(Da50)−Log(Db50))*(Qa50−50%)/(Qa50−Qb50)]
where Qa50 and Qb50 are the cumulative mass percentile values of the data immediately above and below the 50th percentile, respectively; and Da50 and Db50 are the micron sieve size values corresponding to these data.

In the event that the 50th percentile value falls below the finest sieve size (150 um) or above the coarsest sieve size (2360 um), then additional sieves must be added to the nest following a geometric.

### D. Flow Rate Test Method

i. Product is a Granular

As used herein, the phrase “average rate” describes the rate at which the granular product flows from the dispensing passage when the dispensing angle is about 150°. To measure the average rate, the first internal volume, 116, is filled with a predetermined volume, typically at least 50%, preferably 90% of the granular product. The package is tilted to a dispensing angle of 150° for a period of 5 seconds, and the volume of beads which flow out of the dispensing passage during this time is collected and measured by weight, and the flow rate per second is calculated by dividing the weight by 5 seconds. In the case where the granular product stops flowing and/or is completely emptied from the package before the 5 second period is finished, then the weight is divided by amount of time required for the granular product to stop flowing/completely empty from the package. The flow rate is measured and calculated 5 times. From these 5 calculated flow rates the average flow rate, standard deviation, and standard deviation as a percentage of the flow rate are calculated.

As used herein, the term “substantially constant rate”, indicates that when the dispensing angle is measured at dispensing angles of 120° and 150°, the granular product continuously flows out of the package at the average rate where the standard deviation for each dispensing angle is less than about 20 grams of the average flow rate, or from about 0 grams to about 20 grams of the average flow rate. To determine whether or not the flow rate has these characteristics, the above flow rate test method is also conducted at a dispensing angle of 120° and a dispensing angle of 150°.

ii. Product is a Fluid

As used herein, the phrase “average rate” describes the rate at which the fluid product flows from the dispensing passage when the dispensing angle is about 150°. To measure the average rate, the first internal volume, 116, is filled with a predetermined volume, typically at least 50%, preferably 90% of the fluid product. The package is tilted to a dispensing angle of 150° for a period of 5 seconds, and the volume of beads which flow out of the dispensing passage during this time is collected and measured by weight, and the flow rate per second is calculated by dividing the weight by 5 seconds. In the case where the fluid product stops flowing and/or is completely emptied from the package before the 5 second period is finished, then the weight is divided by amount of time required for the fluid product to stop flowing/completely empty from the package. The flow rate is measured and calculated 5 second. From these 5 calculated flow rates the average flow rate, standard deviation, and standard deviation as a percentage of the flow rate are calculated.

As used herein, the term “substantially constant rate”, indicates that when the dispensing angle is measured at dispensing angles of 120° and 150°, the fluid product continuously flows out of the package at the average rate where the standard deviation for each dispensing angle is less than about 30% of the average flow rate, or from about 0 to about 30% of the average flow rate. To determine whether or not the flow rate has these characteristics, the above flow rate test method is also conducted at a dispensing angle of 120° and a dispensing angle of 150°.

### D. EXAMPLES

Examples of the invention are set forth hereinafter by way of illustration and are not intended to be in any way limiting of the invention. The examples are not to be construed as limitations of the present invention since many variations thereof are possible without departing from its spirit and scope.

### Example I

The package of FIGS. 1a and 2, is formed from blow-molded polyethylene or polyethylene terephthalate. The cap and the transition are made of polypropylene by injection molding. The first internal volume can range from 500 ml to 4000 ml and the distinct and separately-formed second internal volume can range from 30 mL to 115 mL. The mouth is round and has a diameter of 5 cm, and the second hollow body member has a threaded closure which forms a seal with the mouth. The flow-regulating passage has a base angle which is about 11°. The side 222 of the flow regulating passage 132 has a height 156 of about 6 mms and a width β of about 20 mms. The base of the flow regulating passage has a width 220 of about 20 mms and a length 224 of about 22 mms.

When tested at dispensing angles of about 120° and 150° according to the flow rate test method herein, the granular product flows out of the dispensing passage and therefore the pouring spout where the standard deviation for each dispensing angle is as follows:

The package is packed with a granular laundry detergent having an average particle diameter of about 400μ. The pouring spout indicates the right direction of tipping for better product pouring with reduced spillage. The bottom of the base has a concave outside to guide product in the bottle to the flow-restriction passage to further improve product flow. The first hollow body member is formed from extrusion blow molded or injection blow molded polyethylene terephthalate, while the cap and the transition are made from injection molded polypropylene.

### Example II

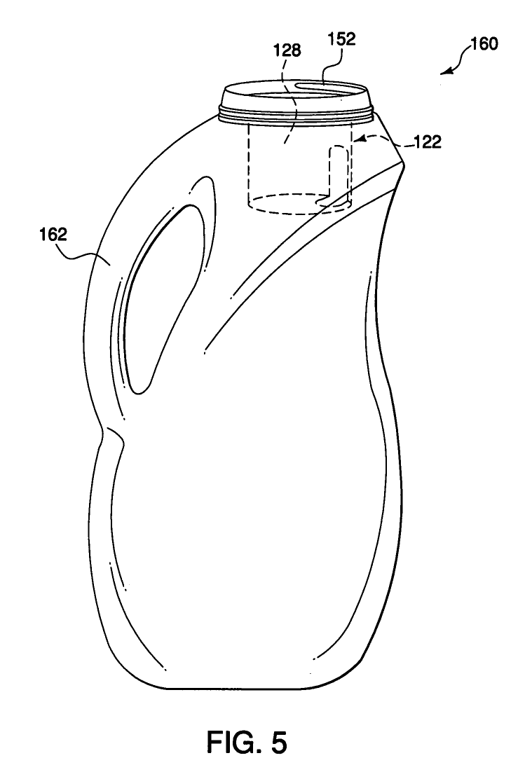

Referring FIG. 5, an alternative embodiment of a package, 160, having a handle 162 is shown. The package 160 has a second hollow body member, 122 with a second interior surface, 128. Fasteners, 152, (e.g., threads), are disposed on the second interior surface, 128. The side 222 of the flow regulating passage 132 has a height 156 of about 6 mms and a width β of about 20 mms. The base of the flow regulating passage has a width 220 of about 20 mms and a length 224 of about 22 mms.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A package for dispensing a pourable product, the package comprising:
A. a first hollow body member having:
i. a first exterior surface; and
ii. a first interior surface opposite the first exterior surface, the first interior surface defining a first internal volume;
B. a second hollow body member, wherein the second hollow body member comprising:
i. a second exterior surface defining a second external volume smaller than the first internal volume;
ii. a second interior surface opposite the second exterior surface, the second interior surface defining a second internal volume, wherein a fastener is formed on said second interior surface;
iii. a base opposite the dispensing passage, and wherein a flow-regulating passage is adjacent to the base.
iv. said flow-regulating passage leading from the second exterior surface to the second interior surface; wherein said flow-regulating passage comprises
a. a flow-regulating base, wherein said flow-regulating base is formed in said base of said second hollow body member and
b. a flow-regulating side, wherein said flow-regulating side is formed in both said second exterior surface and said second interior surface of said second hollow body member, wherein said flow-regulating side has a flow-regulating side width and a flow-regulating side length, said flow-regulating side width is at least about 10 mms and said flow-regulating side length is at least about 10 mms and
v. a dispensing passage leading from the second interior surface to the second exterior surface, wherein the dispensing passage is separate from the flow-regulating passage,
wherein at least a portion of the second hollow body member is within the first internal volume.

2. The package according to claim 1 wherein said flow-regulating base comprises a flow-regulating base width and a flow-regulating base length, said flow-regulations base width is at least about 10 mms and said flow-regulating base width is at least about 10 mms.

3. The package according to claim 1, wherein when the first internal volume is at least about 50% full of the pourable product therein the package may be tilted for dispensing, whereby when tilted for dispensing at a dispensing angle the pourable product flows from the first internal volume through the flow-regulating passage into the second internal volume and from the second internal volume through the dispensing passage out of the package, and wherein when the flow rate is measured and calculated at a dispensing angle of 120°, the standard deviation is less than about 20% of the average flow rate; at a dispensing angle of 150°, the standard deviation is less than about 20% of the average flow rate.

4. The package according to claim 1, wherein said fastener is selected from the group consisting of lugs, grooves, threads, or plug seals.

5. The package according to claim 1, wherein the first hollow body member further comprises a mouth, and wherein the second exterior surface is affixed to the mouth.

6. The package according to claim 1, wherein the first hollow body member further comprises a mouth, and wherein the flow-regulating passage further comprises an edge, and wherein the edge is located at the portion of the second exterior surface which is affixed to the mouth.

7. The package according to claim 1, wherein the second hollow body member comprises a pouring spout.

8. The package according to claim 1, wherein at least a portion of the flow-regulating passage is distal from the dispensing passage.

9. The package according to claim 1, wherein the pourable product has an average particle diameter, and wherein the flow-regulating passage has a width, and wherein the width is at least about 50 times wider than the average particle diameter.

10. The package according to claim 1, wherein the first hollow body member and the second hollow body member are distinct.

11. The package according to claim 1, wherein a first imaginary line is formed by said base, said first hollow body member further comprises a mouth and a second imaginary line is formed by said mouth, wherein said first imaginary line and said second imaginary line span a radial arc identified as γ.

12. The package according to claim 11, wherein said angle, γ, can be between from about 0° to about 180°.

13. The package according to claim 1, wherein the second internal volume is from about 1% to about 25% of the first internal volume.

14. The package according to claim 1, further comprising a cap which removably covers the dispensing passage.

15. The package according to claim 10, wherein the first hollow body member and the second hollow body member are affixed to each other.

16. The package according to claim 1, wherein said pourable product is a granular product therein.

17. The package according to claim 1, wherein said pourable product is a fluid product therein.

18. The package according to claim 16, wherein the granular product is a granular detergent.

19. The package according to claim 1, wherein said pourable product is selected from a group consisting of dry laundry detergent and solid laundry detergent.

20. A package for dispensing a granular product, the package comprising:
A. a first hollow body member having:
i. a first exterior surface; and
ii. a first interior surface opposite the first exterior surface, the first interior surface defining a first internal volume;
B. a cap having:
i. a cap exterior surface;
ii. and a cap interior surface opposite said cap exterior surface, wherein a cap fastener is formed on said cap exterior surface;
C. a second hollow body member, wherein the second hollow body member comprising:
i. a second exterior surface defining a second external volume smaller than the first internal volume;
ii. a second interior surface opposite the second exterior surface, the second interior surface defining a second internal volume, wherein a fastener is formed on said second interior surface;
iii. a base opposite the dispensing passage, and wherein a flow-regulating passage is adjacent to the base.
iv. said flow-regulating passage leading from the second exterior surface to the second interior surface; wherein said flow-regulating passage comprises
a. a flow-regulating base, wherein said flow-regulating base is formed in said base of said second hollow body member and
b. a flow-regulating side, wherein said flow-regulations side is formed in both said second exterior surface and said second interior surface of said second hollow body member wherein said flow-regulating side has a flow-regulating side width and a flow-regulations side length, said flow-regulations side width is at least about 10 mms and said flow-regulating side length is at least about 10 mms and
v. a dispensing passage leading from the second interior surface to the second exterior surface, wherein the dispensing passage is separate from the flow-regulating passage,
wherein at least a portion of the second hollow body member is within the first internal volume.

21. The package according to claim 20, wherein said fastener is a thread and wherein said cap fastener is a thread.
